(19) United States
(12) Patent Application Publication
(10) Pub. No.: US 2025/0100469 A1
(43) Pub. Date: Mar. 27, 2025

(54) WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Mamoru NAGAI, Mie (JP)

(21) Appl. No.: 18/730,806

(22) PCT Filed: Jan. 26, 2023
(86) PCT No.: PCT/JP2023/002344

§ 371 Date: Jul. 22, 2024

(30) Foreign Application Priority Data
Jan. 28, 2022 (JP) 2022-012047

(51) Int. Cl. B60R 16/02; H02G 3/04

(52) U.S. Cl. CPC B60R 16/0215; H02G 3/04

(57) ABSTRACT

A wire harness (W) includes a tubular first electric wire (10) configured as a hollow electric wire, and a protection member (40) in which the first electric wire (10) is accommodated. The first electric wire (10) includes a hollow portion (11) in which a second electric wire (20) is capable of being accommodated. With this configuration, even when the second wire (20) is not accommodated in the hollow portion (11), the clearance between the outer circumferential surface of the first electric wire (10) and the inner circumferential surface of the protection member (40) remains the same. Accordingly, rattling of the first electric wire (10) is suppressed. Therefore, with this configuration, it is possible to suppress rattling of electric wires even when a small number of electric wires are accommodated in the protection member (40).

### TECHNICAL FIELD

The present disclosure relates to a wire harness.

### BACKGROUND

Patent Document 1 discloses a wire harness. This wire harness includes a plurality of electric wires, and a protection member (electric wire protection pipe) that protects the plurality of electric wires.

### PRIOR ART DOCUMENT

### Patent Document

Patent Document 1: JP 2019-083603 A

### SUMMARY OF THE INVENTION

### Problems to be Solved

This type of wire harness has the following problems when an attempt is made to achieve commonality of the protection member across a plurality of types of cars. That is to say, the number of electric wires disposed in the protection member may vary depending on the types of cars. Accordingly, if a protection member tailored to a car with many electric wires is mounted on a car with a smaller number of electric wires, the electric wires will rattle inside the protection member.

Therefore, the present disclosure provides a technology with which rattling of electric wires can be suppressed even when a small number of electric wires are accommodated in the protection member.

### Means to Solve the Problem

A wire harness of the present disclosure includes a tubular first electric wire configured as a hollow electric wire, and a protection member in which the first electric wire is accommodated, wherein the first electric wire includes a hollow portion in which a second electric wire is capable of being accommodated.

### Effect of the Invention

With the present disclosure, it is possible to suppress rattling of electric wires even when a small number of electric wires are accommodated in the protection member.

### BRIEF DESCRIPTION OF THE DRAWINGS

FIG. 1 is a schematic diagram showing a vehicle in which a wire harness of Embodiment 1 is installed.

FIG. 2 is a cross-sectional view of the wire harness taken along line A-A in FIG. 1.

FIG. 3 is a cross-sectional view of the wire harness where a second electric wire is not accommodated in a hollow portion.

FIG. 4 is a cross-sectional view of a wire harness of Embodiment 2.

FIG. 5 is a cross-sectional view of a wire harness of Embodiment 3.

FIG. 6 is a cross-sectional view of a wire harness of Embodiment 4.

### DETAILED DESCRIPTION TO EXECUTE THE INVENTION

### Description of Embodiments of the Present Disclosure

First, aspects of the present disclosure will be listed and described.

(1) A wire harness of the present disclosure includes a tubular first electric wire configured as a hollow electric wire, and a protection member in which the first electric wire is accommodated, wherein the first electric wire includes a hollow portion in which a second electric wire is capable of being accommodated.

With this configuration, the second electric wire is accommodated in the hollow portion, and thus a plurality of electric wires can be accommodated in the protection member. In addition, even when the second wire is not accommodated in the hollow portion, the clearance between the outer circumferential surface of the first electric wire and the inner circumferential surface of the protection member remains the same. Accordingly, rattling of the first electric wire is suppressed. Therefore, with this configuration, it is possible to suppress rattling of electric wires even when a small number of electric wires are accommodated in the protection member.

(2) It is preferable that, in the configuration of (1) above, the first electric wire includes a tubular hollow conductor with the hollow portion, and an insulating coating covering an outer circumference of the hollow conductor.

With this configuration, the outer circumferential surface of the hollow conductor can be electrically insulated from the outside.

(3) It is preferable that, in the configuration of (1) or (2) above, the first electric wire includes a flat portion having a cross section in which a width is larger than a height.

With this configuration, the height of the wire harness can be easily reduced.

(4) It is preferable that, in the configuration of any one of (1) to (3) above, an inner circumference of a cross section of the protection member has a non-circular shape, and an outer circumference of a cross section of the first electric wire has a non-circular shape.

With this configuration, the first electric wire accommodated in the protection member can be easily prevented from rotating.

(5) It is preferable that, in the configuration of (4) above, both the protection member and the first electric wire have a polygonal-tube shape.

With this configuration, the first electric wire accommodated in the protection member can be more easily prevented from rotating.

(6) It is preferable that, in the configuration of any one of (1) to (5) above, the protection member is a shield pipe having electrical conductivity.

With this configuration, the protection member can have both a function of protecting the first electric wire and an electromagnetic shielding function.

(7) It is preferable that, in the configuration of any one of (1) to (6) above, the wire harness is configured to be capable of being installed in a vehicle on which a main battery and a sub-battery are mounted. It is preferable that the first electric wire is to be electrically connected to the main battery, and the second electric wire is to be electrically connected to the sub-battery.

With this configuration, the first electric wire to be electrically connected to the main battery and the second electric wire to be electrically connected to the sub-battery can be accommodated together in the protection member. In addition, even when the above-mentioned wire harness is installed in a vehicle on which no sub-battery is mounted and the second electric wire is not accommodated in the hollow portion of the first electric wire, rattling of the first electric wire in the protection member can be suppressed.

(8) It is preferable that, in the configuration of any one of (1) to (7) above, the second electric wire includes a second hollow portion in which a third electric wire is capable of being accommodated.

With this configuration, the third electric wire can be accommodated in the second hollow portion of the second electric wire, and rattling of the second electric wire can be suppressed even when the third electric wire is not accommodated therein.

In this specification, the “cross section” refers to a transverse cross section, which is a cross section taken in a direction orthogonal to the extension direction of the wire harness.

### Details of Embodiments of the Present Disclosure

The following describes specific examples of the present disclosure with reference to the drawings. Note that the present invention is not limited to these examples, but rather is indicated by the scope of the claims and is intended to include all modifications within the scope and meaning equivalent to the scope of the claims.

### Embodiment 1

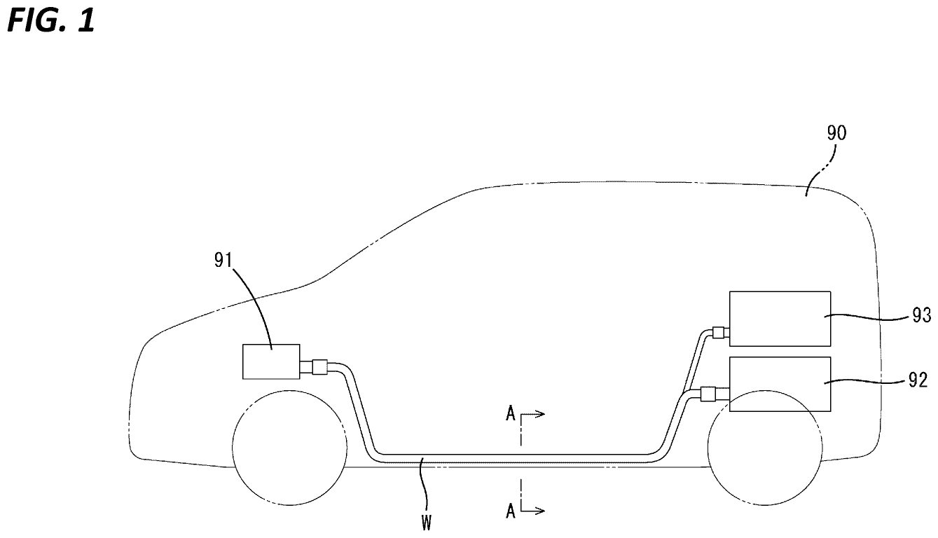

FIG. 1 discloses a vehicle 90 in which a wire harness W of Embodiment 1 is installed. An in-vehicle apparatus 91, a main battery 92, and a sub-battery 93 are mounted on the vehicle 90. The in-vehicle apparatus 91 is disposed on the front side of the vehicle 90, and the main battery 92 and the sub-battery 93 are disposed on the rear side of the vehicle 90. The in-vehicle apparatus 91 is, for example, an electrical junction box containing electric components. The electrical junction box may also be referred to as a junction box, a fuse box, a relay box, etc. The electrical junction box of this embodiment is, for example, a relay box that includes a relay block having relay components (not illustrated). The main battery 92 and the sub-battery 93 are each constituted by a secondary battery such as a lead battery or a lithium-ion battery. The wire harness W is electrically connected to the in-vehicle apparatus 91, and the main battery 92 and the sub-battery 93. Electric power based on the main battery 92 is supplied to the in-vehicle apparatus 91 through the wire harness W. Electric power based on the sub-battery 93 is supplied to the in-vehicle apparatus 91 through the wire harness W when electric power based on the main battery 92 is in short supply.

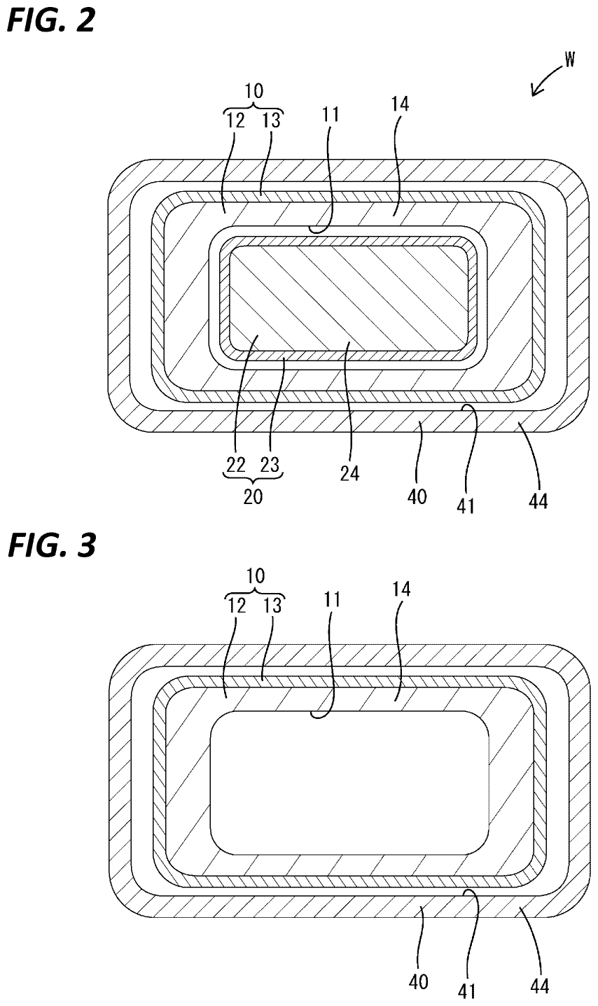

As shown in FIG. 2, the wire harness W includes a first electric wire 10, a second electric wire 20, and a protection member 40.

The first electric wire 10 has a tubular shape, more specifically a polygonal-tube shape, and is configured as a hollow electric wire. The first electric wire 10 includes a hollow portion 11 in which the second electric wire 20 can be accommodated. The first electric wire 10 includes a hollow conductor 12 and an insulating coating 13. The hollow conductor 12 has a tubular shape, more specifically a polygonal-tube shape. The hollow conductor 12 is configured as a busbar. The hollow conductor 12 includes the above-described hollow portion 11. The insulating coating 13 covers the outer circumference of the hollow conductor 12. The insulating coating 13 has a tubular shape, more specifically a polygonal-tube shape. The insulating coating 13 is bonded to the outer circumferential surface of the hollow conductor 12. The first electric wire 10 includes a flat portion 14 having a cross section in which the width is larger than the height. The flat portion 14 has a tubular shape, more specifically a polygonal-tube shape. The hollow portion 11 is provided inside the flat portion 14.

The second electric wire 20 is configured as a solid electric wire. In the cross section of the second electric wire 20, the outer circumferential surface has a rectangular shape. The second electric wire 20 includes a central conductor 22 and a second insulating coating 23. The central conductor 22 is a solid conductor extending in a rod-like manner. The central conductor 22 is configured as a busbar. The central conductor 22 has a rectangular cross-sectional shape. The second insulating coating 23 covers the outer circumference of the central conductor 22. The second insulating coating 23 has a tubular shape, more specifically a polygonal-tube shape. The second insulating coating 23 is bonded to the outer circumferential surface of the central conductor 22. The second electric wire 20 includes a second flat portion 24 having a cross section in which the width is larger than the height. The second flat portion 24 has a rectangular cross-sectional shape. The second flat portion 24 is accommodated in the hollow portion 11 provided inside the flat portion 14. The width of the second flat portion 24 is smaller than the width of the hollow portion 11 provided inside the flat portion 14, and is larger than the height of the hollow portion 11 provided inside the flat portion 14. Accordingly, the rotation in the circumferential direction of the second electric wire 20 accommodated in the hollow portion 11 is restricted.

The protection member 40 is a member for protecting the first electric wire 10, and the first electric wire 10 is accommodated inside the protection member 40. The protection member 40 is configured as, for example, a metal shield pipe having electrical conductivity. The protection member 40 has a tubular shape, more specifically a polygonal-tube shape. The protection member 40 includes a protection member-side hollow portion 41 in which the first electric wire 10 can be accommodated. The protection member 40 includes a protection member-side flat portion 44 having a cross section in which the width is larger than the height. The protection member-side flat portion 44 has a tubular shape, more specifically a polygonal-tube shape. The protection member-side hollow portion 41 is provided inside the protection member-side flat portion 44, and the above-described flat portion 14 of the first electric wire 10 is accommodated in the protection member-side hollow portion 41. The width of the flat portion 14 is smaller than the width of the protection member-side hollow portion 41 provided inside the protection member-side flat portion 44, and is larger than the height of the protection member-side hollow portion 41 provided inside the protection member-side flat portion 44. Accordingly, the rotation in the circumferential direction of the first electric wire 10 accommodated in the protection member-side hollow portion 41 is restricted.

One end of the first electric wire 10 is to be electrically connected to the in-vehicle apparatus 91, and the other end is to be electrically connected to the main battery 92. One end of the second electric wire 20 is to be electrically connected to the in-vehicle apparatus 91, and the other end is to be electrically connected to the sub-battery 93.

Incidentally, the wire harness W can also be installed in a vehicle on which the sub-battery 93 is not mounted. In this case, as shown in FIG. 3, the second electric wire 20 to be connected to the sub-battery 93 is not accommodated in the hollow portion 11. However, the clearance between the outer circumferential surface of the first electric wire 10 and the inner circumferential surface of the protection member 40 remains the same. Accordingly, rattling of the first electric wire 10 can be suppressed even when the second electric wire 20 is not accommodated in the hollow portion 11. Therefore, with this wire harness W, it is possible to suppress rattling of electric wires even when a small number of electric wires are accommodated in the protection member 40.

Furthermore, the first electric wire 10 includes the tubular hollow conductor 12 that includes the hollow portion 11, and the insulating coating 13 that covers the outer circumference of the hollow conductor 12. With this configuration, the outer circumferential surface of the hollow conductor 12 can be electrically insulated from the protection member 40.

Furthermore, the first electric wire 10 includes the flat portion 14 having a cross section in which the width is larger than the height. The protection member 40 includes the protection member-side flat portion 44 having a cross section in which the width is larger than the height. The flat portion 14 is disposed in the protection member-side flat portion 44. With this configuration, the height of the wire harness W can be easily reduced.

Furthermore, both the protection member 40 and the first electric wire 10 have a polygonal-tube shape. With this configuration, the first electric wire 10 accommodated in the protection member 40 can be more easily prevented from rotating.

Furthermore, the protection member 40 is a shield pipe having electrical conductivity. With this configuration, the protection member 40 can have both a function of protecting the first electric wire 10 and an electromagnetic shielding function.

### Embodiment 2

Although the second electric wire is a solid wire in Embodiment 1, it may also be a hollow electric wire. In Embodiment 2, an example in which the second electric wire is a hollow electric wire will be described. In the following description, the configurations that are the same as those of Embodiment 1 are denoted by the same reference numerals, and detailed descriptions are omitted.

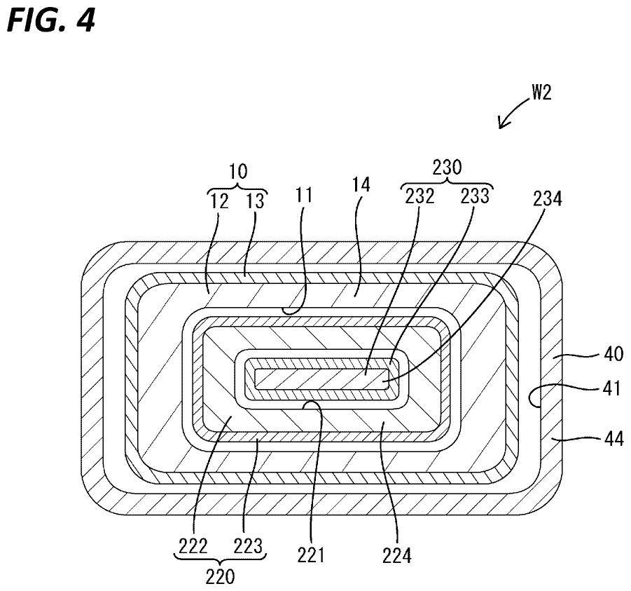

As shown in FIG. 4, a wire harness W2 of Embodiment 2 includes the first electric wire 10, a second electric wire 220, a third electric wire 230, and the protection member 40.

The second electric wire 220 has a tubular shape, more specifically a polygonal-tube shape, and is configured as a hollow electric wire. The second electric wire 220 includes a second hollow portion 221 in which the third electric wire 230 can be accommodated. The second electric wire 220 includes a second hollow conductor 222 and a second insulating coating 223. The second hollow conductor 222 has a tubular shape, more specifically a polygonal-tube shape. The second hollow conductor 222 is configured as a busbar. The second hollow conductor 222 includes the above-described second hollow portion 221. The second insulating coating 223 covers the outer circumference of the second hollow conductor 222. The second insulating coating 223 has a tubular shape, more specifically a polygonal-tube shape. The second insulating coating 223 is bonded to the outer circumferential surface of the second hollow conductor 222. The second electric wire 220 includes a second flat portion 224 having a cross section in which the width is larger than the height. The second flat portion 224 has a tubular shape, more specifically a polygonal-tube shape. The second hollow portion 221 is provided inside the second flat portion 224. The second flat portion 224 is accommodated in the hollow portion 11 provided inside the flat portion 14. The width of the second flat portion 224 is smaller than the width of the hollow portion 11 provided inside the flat portion 14, and is larger than the height of the hollow portion 11 provided inside the flat portion 14. Accordingly, the rotation in the circumferential direction of the second electric wire 220 accommodated in the hollow portion 11 is restricted.

The third electric wire 230 is configured as a solid electric wire. In the cross section of the third electric wire 230, the outer circumferential surface has a rectangular shape. The third electric wire 230 includes a central conductor 232 and a third insulating coating 233. The central conductor 232 is a solid conductor extending in a rod-like manner. The central conductor 232 is configured as a busbar. The central conductor 232 has a rectangular cross-sectional shape. The third insulating coating 233 covers the outer circumference of the central conductor 232. The third insulating coating 233 has a tubular shape, more specifically a polygonal-tube shape. The third insulating coating 233 is bonded to the outer circumferential surface of the central conductor 232. The third electric wire 230 includes a third flat portion 234 having a cross section in which the width is larger than the height. The third flat portion 234 is accommodated in the second hollow portion 221 provided inside the second flat portion 224. The width of the third flat portion 234 is smaller than the width of the second hollow portion 221 provided inside the second flat portion 224, and is larger than the height of the second hollow portion 221 provided inside the second flat portion 224. Accordingly, the rotation in the circumferential direction of the third electric wire 230 accommodated in the second hollow portion 221 is restricted.

With this configuration, the third electric wire 230 can be accommodated in the second hollow portion 221 of the second electric wire 220, and rattling of the second electric wire 220 can be suppressed even when the third electric wire 230 is not accommodated therein.

### Embodiment 3

Although the conductor portion of the second electric wire is a busbar in Embodiments 1 and 2, it need not be a busbar. In addition, although a single second electric wire is used in Embodiments 1 and 2, two or more second electric wires may also be used. In Embodiment 3, an example in which a plurality of second electric wires are provided and the conductor portion in each second electric wire is a single-core wire will be described. In the following description, the configurations that are the same as those of Embodiment 1 are denoted by the same reference numerals, and detailed descriptions are omitted.

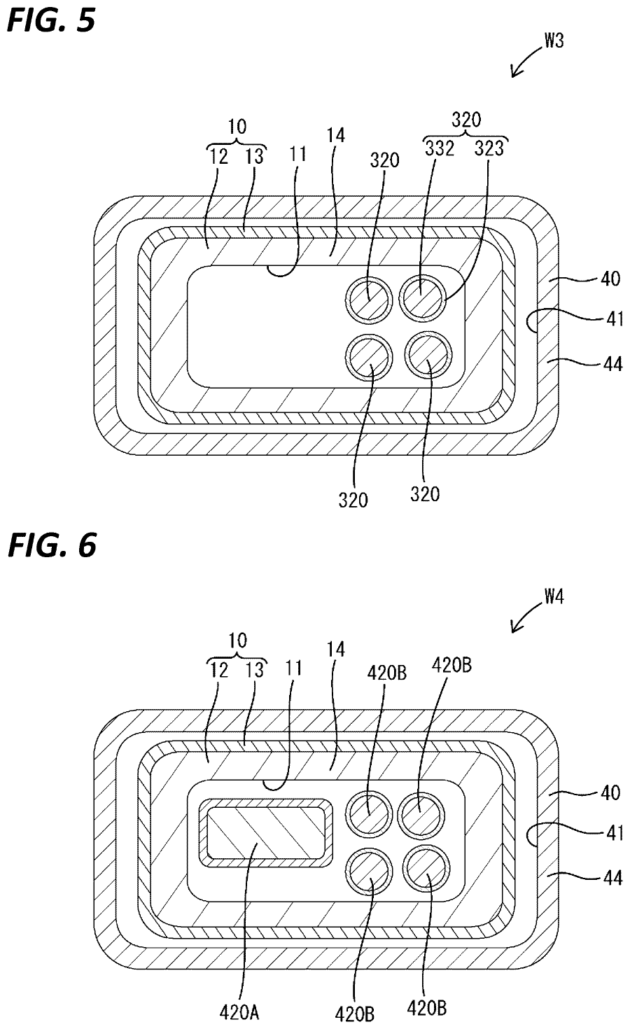

As shown in FIG. 5, a wire harness W3 of Embodiment 3 includes the first electric wire 10, second electric wires 320, and the protection member 40. A plurality of second electric wires 320 (four second electric wires 320 in this embodiment) are accommodated in the hollow portion 11 of the first electric wire 10.

Each of the second electric wires 320 has a circular cross-sectional shape. The second electric wire 320 includes a core wire 322 and a second insulating coating 323. The core wire 322 has electrical conductivity. The core wire 322 is a columnar single-core wire. The second insulating coating 323 covers the outer circumference of the core wire 322. The second insulating coating 323 has a tubular shape, more specifically a polygonal-tube shape. The second insulating coating 323 is bonded to the outer circumferential surface of the core wire 322.

### Embodiment 4

Although a plurality of second electric wires of the same type are provided in Embodiment 3, a configuration may also be employed in which second electric wires of different types are provided. In Embodiment 4, an example in which second electric wires of different types are provided will be described. In the following description, the configurations that are the same as those of Embodiment 1 are denoted by the same reference numerals, and detailed descriptions are omitted.

As shown in FIG. 6, a wire harness W4 of Embodiment 4 includes the first electric wire 10, second electric wires 420A and 420B, and the protection member 40. A single second electric wire 420A and a plurality of second electric wires 420B (four second electric wires 420B in this embodiment) are accommodated in the hollow portion 11 of the first electric wire 10. The shape of the second wire 420A corresponds to the shape of the second electric wire 20 of Embodiment 1 with a reduced width and a reduced height. The second electric wires 420B are in the same form as the second electric wires 320 of Embodiment 3.

### Other Embodiments of the Present Disclosure

The embodiments disclosed herein are exemplary in all respects, and should be construed as being not limitative.

(1) Although the hollow conductor of the first electric wire is a busbar in the embodiments above, it need not be a busbar. For example, the hollow conductor may be a columnar single-core wire or a twisted wire. Although the conductor portion in the second electric wire is a busbar or a columnar single-core wire in the embodiments above, it may be a component having different configuration, such as a twisted wire.

(2) Although the embodiments above have a configuration in which the insulating portion disposed between the conductor portion of the first electric wire and the protection member is bonded to the conductor portion of the first electric wire, the insulating portion may be bonded to the protection member or may be bonded to neither the conductor portion of the first electric wire nor the protection member.

(3) Although the embodiment 1 above have a configuration in which the insulating portion disposed between the conductor portion of the first electric wire and the conductor portion of the second electric wire is bonded to the conductor portion of the second electric wire, the insulating portion may be bonded to the conductor portion of the first electric wire or may be bonded to neither the conductor portion of the first electric wire nor the conductor portion of the second electric wire.

(4) The first electric wire need not include the flat portion. The second electric wire need not include the second flat portion. The protection member need not include the protection member-side flat portion.

(5) The first electric wire and the protection member need not have a polygonal-tube shape. The first electric wire and the protection member may have, for example, a cylindrical shape or a tubular shape having a semicircular cross-sectional shape. Also, the first electric wire and the protection member may have different shapes.

(6) The protection member need not have electrical conductivity. The protection member may be made of a synthetic resin rather than a metal. The protection member may be a corrugated tube.

(7) The protection member need not have a tubular shape as long as the first electric wire can be accommodated therein.

(8) Although the first electric wire is provided with a single hollow portion in the embodiments above, a plurality of hollow portions may be provided. That is to say, a plurality of hollow portions may be disposed in parallel.

### LIST OF REFERENCE NUMERALS

10: First electric wire
11: Hollow portion
12: Hollow conductor
13: Insulating coating
14: Flat portion
20: Second electric wire
22: Central conductor
23: Second insulating coating
24: Second flat portion
40: Protection member
41: Protection member-side hollow portion
44: Protection member-side flat portion
90: Vehicle
91: In-vehicle apparatus
92: Main battery
93: Sub-battery
220: Second electric wire
221: Second hollow portion
222: Second hollow conductor
223: Second insulating coating
224: Second flat portion
230: Third electric wire
232: Central conductor
233: Third insulating coating
234: Third flat portion
320: Second electric wire
322: Core wire
323: Second insulating coating
420A: Second electric wire
420B: Second electric wire
W: Wire harness
W2: Wire harness
W3: Wire harness
W4: Wire harness

1. A wire harness comprising:
a tubular first electric wire configured as a hollow electric wire; and
a protection member in which the first electric wire is accommodated,
wherein the first electric wire includes a hollow portion in which a second electric wire is capable of being accommodated.

2. The wire harness according to claim 1,
wherein the first electric wire includes a tubular hollow conductor with the hollow portion, and an insulating coating covering an outer circumference of the hollow conductor.

3. The wire harness according to claim 1,
wherein the first electric wire includes a flat portion having a cross section in which a width is larger than a height.

4. The wire harness according to claim 1,
wherein an inner circumference of a cross section of the protection member has a non-circular shape, and
an outer circumference of a cross section of the first electric wire has a non-circular shape.

5. The wire harness according to claim 4,
wherein both the protection member and the first electric wire have a polygonal-tube shape.

6. The wire harness according to claim 1,
wherein the protection member is a shield pipe having electrical conductivity.

7. The wire harness according to claim 1,
wherein the wire harness is configured to be capable of being installed in a vehicle on which a main battery and a sub-battery are mounted,
the first electric wire is to be electrically connected to the main battery, and
the second electric wire is to be electrically connected to the sub-battery.

8. The wire harness according to claim 1,
wherein the second electric wire includes a second hollow portion in which a third electric wire is capable of being accommodated.
